(19) United States
(12) Patent Application Publication
(10) Pub. No.: US 2022/0280817 A1
(43) Pub. Date: Sep. 8, 2022

(54) Nostril Wearable Filtering Device

(71) Applicant: Fulton Carson, Raymond, MS (US)

(72) Inventor: Fulton Carson, Raymond, MS (US)

(21) Appl. No.: 17/189,912

(22) Filed: Mar. 2, 2021

(51) Int. Cl. A62B 23/06

(52) U.S. Cl. CPC A62B 23/06

(57) ABSTRACT

A nostril wearable filtering device for reducing exposure to particulates includes a cylinder, which is tubular and resiliently compressible. The cylinder can be compressed between digits of a hand of a user, positioning the user to insert the cylinder, by a first end thereof, into a nostril. A filter is engaged to the cylinder and extends across a second end of the cylinder. The cylinder is one of a pair of cylinders. Each cylinder of the pair of cylinders can be compressed and inserted into a respective nostril of the user. The cylinders then expand so that the cylinders conform to and sealably engage interior surfaces of the nostrils. The filters filter air passing therethrough, to reduce particulate content of the air, prior to the air entering lungs of the user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to filtering devices and more particularly pertains to a new filtering device for reducing exposure to particulates. The present invention discloses a filtering device comprising a pair of compressible tubular cylinders having integral filters.

### (2) Description of Related Art Including Information Disclosed Under 37 CFR 1.97 and 1.98

The prior art relates to filtering devices directed to filtering air as it passes through nostrils of a user to the user's lungs. Such prior art filtering devices may comprise interconnected pairs of cylinders having flanges therearound which engage nostril walls, interconnected pairs of tubular cylinders insertable into nostrils and engageable to carbon filters, pipes having flanges extending radially from one end so as to form seals with nostrils upon inhaling of air, linked pairs of rings, wherein each ring can be inserted into a nostril and fitted with a filter, and filters that are magnetically engageable to noses. What is lacking in the prior art is a filtering device comprising a pair of compressible tubular cylinders having integral filters.

### BRIEF SUMMARY OF THE INVENTION

An embodiment of the disclosure meets the needs presented above by generally comprising a cylinder, which is tubular and resiliently compressible. The cylinder is configured to be compressed between digits of a hand of a user, positioning the user to insert the cylinder, by a first end thereof, into a nostril. A filter is engaged to the cylinder and extends across a second end of the cylinder. The cylinder is one of a pair of cylinders. Each cylinder of the pair of cylinders is configured to be compressed and inserted into a respective nostril of the user. The cylinders are configured to expand so that the cylinders conform to and sealably engage interior surfaces of the nostrils. The filters are configured to filter air passing therethrough, to reduce particulate content of the air, prior to the air entering lungs of the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear isometric perspective view of a nostril wearable filtering device according to an embodiment of the disclosure.

FIG. 2 is a front isometric perspective view of an embodiment of the disclosure.

FIG. 3 is a side view of an embodiment of the disclosure.

FIG. 4 is a cross-sectional view of an embodiment of the disclosure.

FIG. 5 is a front view of an embodiment of the disclosure.

FIG. 6 is an in-use view of an embodiment of the disclosure.

FIG. 7 is a kit view of an embodiment of the disclosure.

FIG. 8 is a flow diagram for a method utilizing an embodiment of the disclosure.

### DETAILED DESCRIPTION OF THE INVENTION

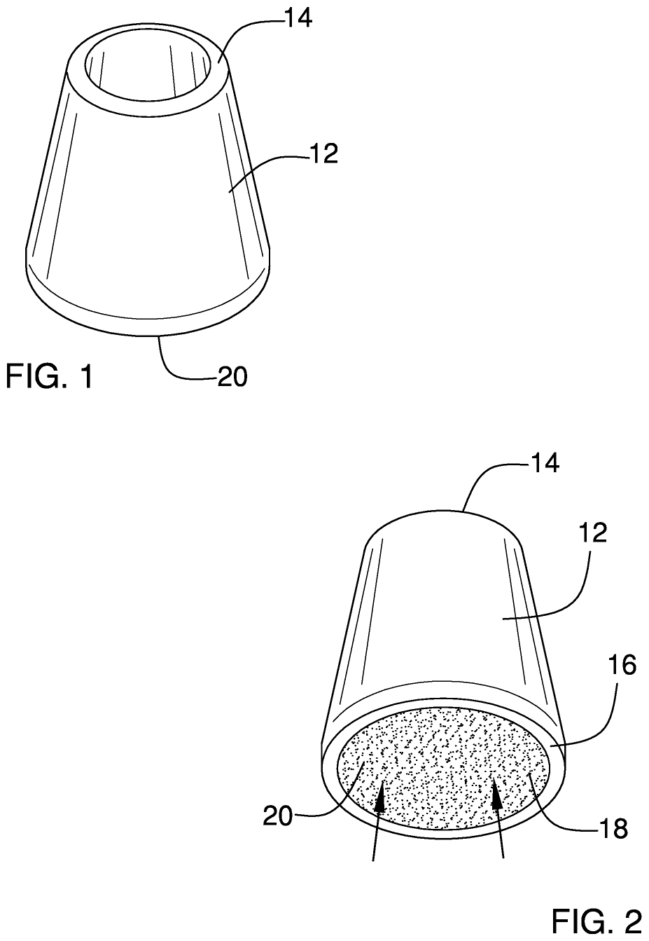

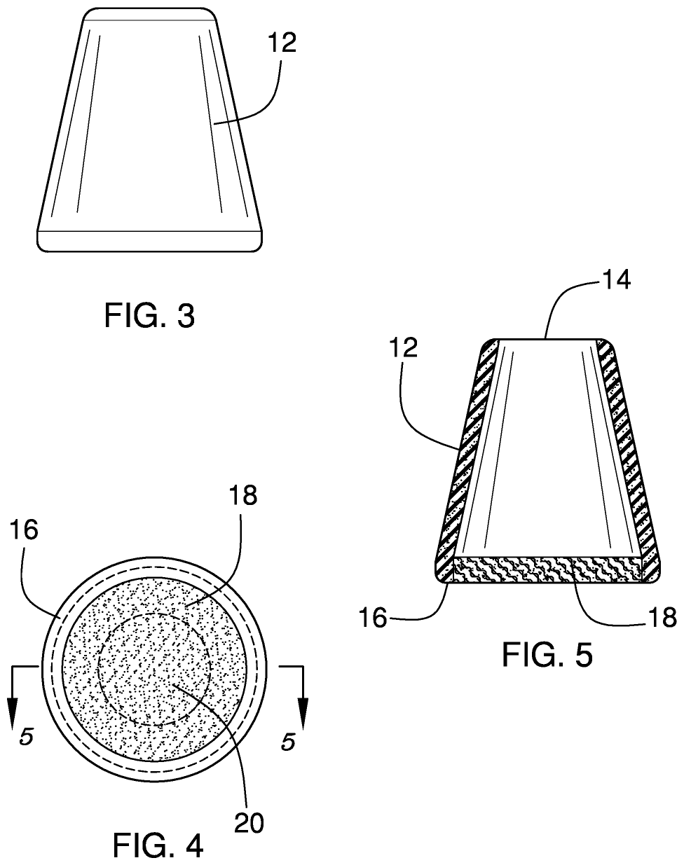

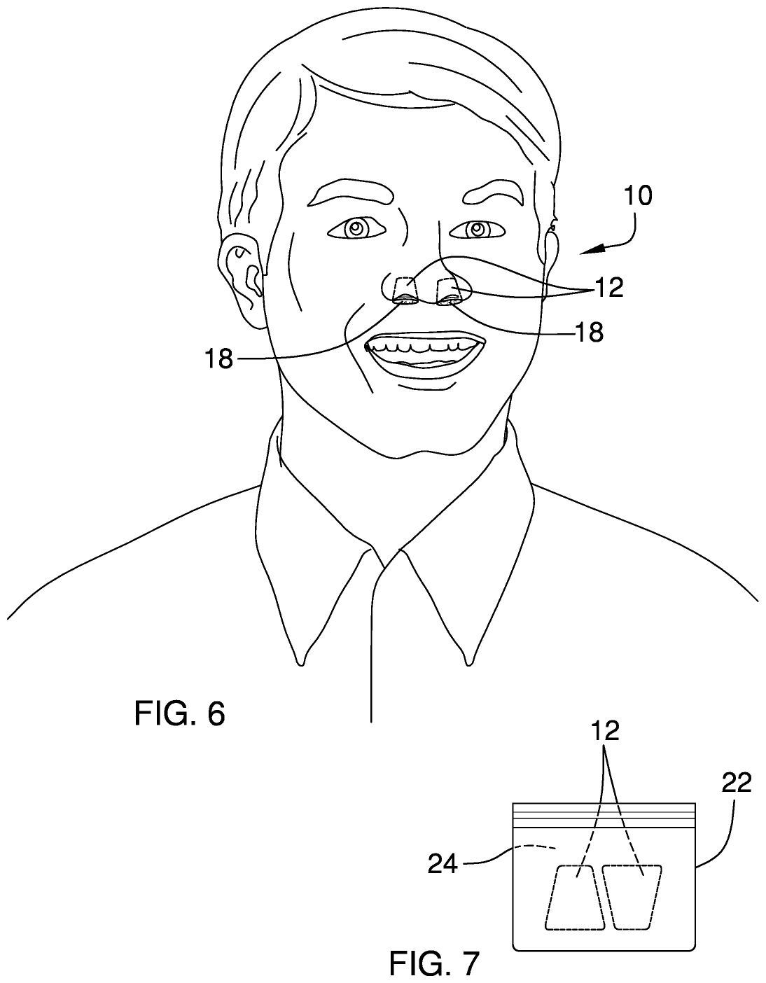

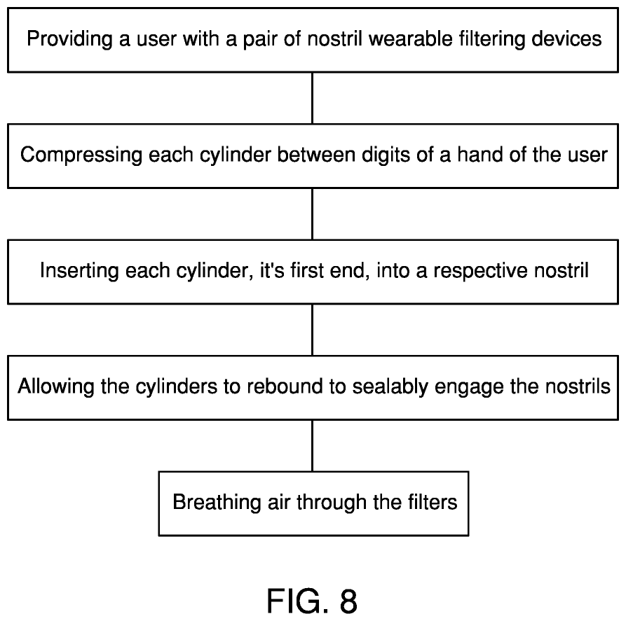

With reference now to the drawings, and in particular to FIGS. 1 through 8 thereof, a new filtering device embodying the principles and concepts of an embodiment of the disclosure and generally designated by the reference numeral 10 will be described.

As best illustrated in FIGS. 1 through 8, the nostril wearable filtering device 10 generally comprises a cylinder 12, which is tubular and resiliently compressible. The cylinder 12 is configured to be compressed between digits of a hand of a user, positioning the user to insert the cylinder 12, by a first end 14 thereof, into a nostril. The cylinder 12 comprises foamed elastomer, silicone, or rubber. The cylinder 12 may be conically frustrum shaped, such that a second end 16 of the cylinder 12 is circumferentially larger than the first end 14. The present invention anticipates the cylinder 12 being alternately shaped, such as, but not limited to, cylindrically shaped, multiple concentric donut shaped, and the like.

A filter 18 is engaged to the cylinder 12 and extends across the second end 16 of the cylinder 12. The filter 18 is configured to capture particulates having diameters of from 0.0001 to 1000 micrometers. The filter 18 may comprise a plurality of fibers 20, or other filtering means, such as, but not limited to, membranes, charged particles, and the like.

The filter 18 may be configured to capture particulates having diameters larger than approximately 0.01 micrometers and smaller than 1000 micrometers, so that the filter 18 is configured to filter bacteria from air passing therethrough. The filter 18 also may be configured to capture particulates having diameters larger than approximately 0.003 micrometers and smaller than 1000 micrometers, so that the filter 18 is configured to filter viruses from air passing therethrough.

The cylinder 12 is one of a pair of cylinders 12. Each cylinder 12 of the pair of cylinders 12 is configured to be compressed and inserted into a respective nostril of the user. The cylinders 12 are configured to expand so that the cylinders 12 conform to and sealably engage interior surfaces of the nostrils. The filters 18 are configured to filter air passing therethrough, to reduce particulate content of the air, prior to the air entering lungs of the user.

The device 10 also may comprise a shell 22, which defines an interior space 24 in which the pair of cylinders 12 are sealably positioned. The shell 22 is configured to deter contamination of the pair of cylinders 12 prior to use. The shell 22 comprises plastic so that the shell 22 is openable, by tearing of the plastic, allowing the user to access the pair of cylinders 12. The present invention also anticipates the shell 22 comprising other containing means, such as, but not limited to, capped tubes, clamshell containers, and the like.

In use, the device 10 enables a method 26 of filtering air passing through nostrils of a user. The method 26 comprise a first step 28 of providing a user with a pair of nostril wearable filtering devices, as per the disclosure above and as shown in FIGS. 1-7. A second step 30 of the method 26 entails compressing each cylinder 12 between digits of a hand of the user, so that, in a third step 32, each cylinder 12 can be inserted, by its first end 14, into a respective nostril. A fourth step 34 of the method 26 entails allowing the cylinders 12 to rebound so that the cylinders 12 conform to and sealably engage interior surfaces of the nostrils. The fifth step 36 of the method 26 entails normal breathing of air through the filters 18, to reduce particulate content of the air, prior to the air entering lungs of the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A nostril wearable filtering device comprising:
a cylinder, the cylinder being tubular and resiliently compressible, wherein the cylinder is configured for compressing between digits of a hand of a user, positioning the user for inserting the cylinder, by a first end thereof, into a nostril;
a filter engaged to the cylinder such that the filter extends across a second end of the cylinder; and
the cylinder being one of a pair of cylinders, wherein each cylinder of the pair of cylinders is configured for compressing and inserting into a respective nostril of the user, wherein the cylinders are configured for expanding, such that the cylinders conform to and sealably engage interior surfaces of the nostrils, wherein the filters are configured for filtering air passing therethrough, for reducing particulate content of the air, prior to the air entering lungs of the user.

2. The nostril wearable filtering device of claim 1, wherein the cylinder comprises foamed elastomer, silicone, or rubber.

3. The nostril wearable filtering device of claim 1, wherein the cylinder is conically frustrum shaped, such that the second end is circumferentially larger than the first end.

4. The nostril wearable filtering device of claim 1, wherein the filter is configured for capturing particulates having diameters of from 0.0001 to 1000 micrometers.

5. The nostril wearable filtering device of claim 4, wherein the filter is configured for capturing particulates having diameters larger than approximately 0.01 micrometers and smaller than 1000 micrometers, wherein the filter is configured for filtering bacteria from air passing therethrough.

6. The nostril wearable filtering device of claim 5, wherein the filter is configured for capturing particulates having diameters larger than approximately 0.003 micrometers and smaller than 1000 micrometers, wherein the filter is configured for filtering viruses from air passing therethrough.

7. The nostril wearable filtering device of claim 1, wherein the filter comprises a plurality of fibers.

8. The nostril wearable filtering device of claim 1, further including a shell defining an interior space, the pair of cylinders being sealably positioned within the interior space, wherein the shell is configured for deterring contamination of the pair of cylinders.

9. The nostril wearable filtering device of claim 8, wherein the shell comprises plastic, such that the shell is openable, by tearing thereof, for accessing the pair of cylinders.

10. A method of filtering air passing through nostrils of a user, the method comprising the steps of:
providing a user with a pair of nostril wearable filtering devices, wherein each nostril wearable filtering device comprises:
a cylinder, the cylinder being tubular and resiliently compressible, and
a filter engaged to the cylinder such that the filter extends across a second end of the cylinder;
compressing each cylinder between digits of a hand of the user;
inserting each cylinder, by a first end thereof, into a respective nostril;
allowing the cylinders to rebound, such that the cylinders conform to and sealably engage interior surfaces of the nostrils; and
breathing air through the filters, for reducing particulate content of the air, prior to the air entering lungs of the user.

11. A nostril wearable filtering device comprising:
a cylinder, the cylinder being tubular and resiliently compressible, wherein the cylinder is configured for compressing between digits of a hand of a user, positioning the user for inserting the cylinder, by a first end thereof, into a nostril, the cylinder comprising foamed elastomer, silicone, or rubber, the cylinder being conically frustrum shaped, such that the second end is circumferentially larger than the first end;
a filter engaged to the cylinder such that the filter extends across a second end of the cylinder, the filter being configured for capturing particulates having diameters of from 0.0001 to 1000 micrometers, the filter being configured for capturing particulates having diameters larger than approximately 0.01 micrometers and smaller than 1000 micrometers, wherein the filter is configured for filtering bacteria from air passing therethrough, the filter being configured for capturing particulates having diameters larger than approximately 0.003 micrometers and smaller than 1000 micrometers, wherein the filter is configured for filtering viruses from air passing therethrough, the filter comprising a plurality of fibers;
the cylinder being one of a pair of cylinders, wherein each cylinder of the pair of cylinders is configured for compressing and inserting into a respective nostril of the user, wherein the cylinders are configured for expanding, such that the cylinders conform to and sealably engage interior surfaces of the nostrils, wherein the filters are configured for filtering air passing therethrough, for reducing particulate content of the air, prior to the air entering lungs of the user; and
a shell defining an interior space, the pair of cylinders being sealably positioned within the interior space, wherein the shell is configured for deterring contamination of the pair of cylinders, the shell comprising plastic, such that the shell is openable, by tearing thereof, for accessing the pair of cylinders.
